(19) United States
(12) Patent Application Publication
(10) Pub. No.: US 2015/0064391 A1
(43) Pub. Date: Mar. 5, 2015

(54) METHOD OF MAKING A 3D OBJECT FROM COMPOSITE MATERIAL

(71) Applicant: William Anton TRONDL, (US)

(72) Inventor: William Anton Trondl, Rosny (AU)

(21) Appl. No.: 14/389,892

(22) PCT Filed: Mar. 14, 2013
(86) PCT No.: PCT/AU2013/000249

§ 371 Date: Oct. 1, 2014

(30) Foreign Application Priority Data
Apr. 2, 2012 (AU) 2012901309

(51) Int. Cl. B32B 1/00; B32B 37/18

(52) U.S. Cl. CPC B32B 1/00; B32B 37/18; B32B 2250/44; B32B 2605/18; B32B 2605/12
USPC 428/80; 156/60; 156/280

(57) ABSTRACT

The invention provides a method of producing an object made of a composite material said object being relatively strong and light weight and having a complex three-dimensional configuration. The method involves bonding a series of shaped sections of material each with a laminated face to form the object which when laminated, ties the internal and external laminations together to form an array of structural members. The method provides the added advantage that the object may be formed without using a mould.

### TECHNICAL FIELD

The present invention relates to production of 3D objects made of composite material which are relatively strong and light weight.

### BACKGROUND ART

The need for strong light weight material for construction of all types of objects such as vehicles including watercraft and aircraft has been ongoing. Fiberglass was an innovation to the boat building and craft industries in the 1950s.

Building on 1950s technology a number of proposals to provide strong light weight material have been put forward. These include the use of composite materials in male/female molds such as in U.S. Pat. No. 5,526,767 by McGuiness, its use in closed molds as in U.S. Pat. No. 4,910,067 by O'Neill and improved hybrid fiberglass composites which resist impact damage such as those disclosed in U.S. Pat. No. 7,740,392 by Kismarton.

GB 1307868 in the name of CMN dates from 1970 and discloses use of lathes made of foam in the construction of a boat hull. Each lath is of a constant transverse cross-section and has overhanging sheet material which is designed to cover the adjacent lath when glued together in a series.

U.S. Pat. No. 5,462,623 by Day discloses production of generally rectangular boards and billets for use in structural and non-structural applications.

US patent application No. 2007/0054102 in the name of Baig discloses production of a composite lightweight board useful for constructing walls, suspended ceilings and the like whereas U.S. Pat. No. 4,336,676 by Artzer relates to production of a panel and U.S. Pat. No. 4,536,427 by Kohn discloses a scrimless contourable core for sandwiching between sheets of resin reinforced fiberglass.

While the above proposals may address some of the issues with production of light weight material having a high strength to weight ratio they are not entirely satisfactory because of difficulty of use and/or high production costs, particularly in relation to the production of complex 3D objects. Further changes to the design of an object may involve the production of a new mould adding to costs.

The above references to and descriptions of prior proposals or products are not intended to be, and are not to be construed as, statements or admissions of common general knowledge in the art.

### DISCLOSURE OF THE INVENTION

In a first aspect the invention provides a method of producing an object made of a composite material said object being relatively strong and light weight and having a complex three-dimensional configuration, said method comprising the steps of a) providing a plurality of appropriately shaped sections bonded together into the three-dimensional configuration, each section comprising a suitable core material with a suitable laminated face extending to an edge thereof, said configuration having first and second surfaces incorporating said edges; b) laminating or otherwise sealing said surfaces and edges; c) wherein said laminated faces form a series of structural webs connecting said first and second surfaces; and d) wherein said sections provide rigidity to the nascent configuration when said sections are sequentially assembled.

The invention is partly predicated on the inventor's surprising realization that a complex 3 dimensional object may be made using I-beam-like webs of structural material where the first and second surfaces (which correspond to the capped flanges of an I-beam) form a continuous outer surface of the object. Specifically the method involves bonding a series of shaped sections of material each with a laminated face to form the desired object which when laminated, ties the internal and external laminations together to form an array of structural members. The method provides the added advantage that the object may be formed without using a mould. This means that changes to the design of an object do not involve the expensive step of having to produce a new mould.

The term “an object” refers to any object where it is desired to use a composite material to make an object which is relatively strong and light weight. The term also includes part of an object. A wide variety of objects are contemplated, such as, but not limited to a pressure or vacuum vessel, a transportable liquid tank such as that on a fuel tanker, a vehicular bridge section or ramp for a truck or utility mount, a man handle ramp or bridge, a RORO ramp for ships, a vacuum pipe, an aircraft wing or other aircraft parts, an aircraft body, an aircraft fuel tank, a space capsule, a watercraft, kayak, canoe, a car body, ski-mobile body, a train carriage, a survival capsule, a wind turbine blade; virtually anything where weight reduction is an advantage. In addition the invention may be used to produce a “plug” so that a mould can be made for conventionally made fiber glass objects.

The term “composite material” refers to a combination of two or more different materials. The composite material referred to in this document is a layered composite which may be of foam fillers and reinforcing material such as fiberglass (glass reinforced plastic).

The term “being relatively strong and light weight” means comparatively strong for its weight and refers to a relatively high strength to weight ratio. Strength to weight ratio is the relationship between the strength of a material, such as its deflection under a given load divided by the weight of the material which supports that load.

The term “complex 3 dimensional configuration” refers to a shape or in the case of step a) above the precursor of a shape which is not primarily flat or 2 dimensional but which has a profile which is curved or re-curved such as an object which is shaped to be hydrodynamic or aerodynamic and also includes toroidal objects, hollow objects, tubular objects and objects with lumens.

The term “appropriately shaped sections” refers to the sheets or blocks used to build up the object. For example if it is desired to build the hull of a boat each of the sections are cut to conform to the shape of the corresponding area of the cross-section of the hull. Similarly if it is desired to make a surfboard, each of the sections is cut to conform to the shape of the corresponding area of a longitudinal section of the surfboard.

The term “suitable core material” refers to a substrate or scaffold and may be of any suitable light weight material which functions as a substrate or scaffold. The material may be cellular in nature such as polyurethane, urethane rigid foam, polystyrene rigid foam, corrugated aluminium foil or balsa wood. In some instances the core may significantly add to the strength of the object, depending on the choice of substrate. The core material may be any relatively light weight material compatible with the structural/laminating material and compatible with the intended use of the object.

The term “suitable laminated face” refers to strong or structural material compatible with the core material and of suitable strength to provide structural integrity to the object under conditions of normal use. The laminated face has sufficient thickness of material as to provide a structural benefit within given weight restraints. The laminated face may be made of glass reinforced plastic (GRP) and the like, glass fibre, Kevlar fibre, carbon fiber reinforcement of resins or plastics such as polyester and epoxy resins, acrylonitrile butadiene styrene (ABS), Acetone-butanol-ethanol (ABE), aluminium or other suitable material.

The term “extending to an edge of the section” refers to the lamination covering that face of the section all the way to its edge.

The sections are bonded together by any appropriate means. In some circumstances the same material as the laminated face is used.

In the case of GRP and urethane foam, the resin that impregnates the fibers, bonds them to the foam thereby forming the laminated face. This same material would be used to bond together the sections. Most commonly this material is Polyester or Epoxy resin.

The term “first and second surfaces” refers to the outer surface of the object prior to laminating or sealing. The outer surface may have an inside and an outside or otherwise opposing surfaces which may meet, around the perimeter of the object such as the edges of a surf board, for example.

The term “laminating or otherwise sealing” refers to providing a layer of structural material such as that used on the laminated face of the shaped section or similar material.

The term “structural web” refers to vanes or strips of structural material. Preferably the webs are disposed perpendicular to, or substantially perpendicular to, the first and second surfaces. As mentioned above the first and second surfaces are generally the inside and outside of an object such as a boat hull or the top side and bottom side of a surfboard, for example.

The webs are formed by sealing the external surfaces and edges of laminated faces. These webs tie the surfaces together creating an array of I-beam like structures throughout the object, the lamination forming a unitary or integral array of the functional equivalent of a capped flange in an I-beam. Specifically, the lamination is bonded to core material and the edge of webs in a way that provides maximum adhesion and hence provides tensile and torsional strength to the object.

In a second aspect the invention provides a method of producing an object made of a composite material, said object having a complex three-dimensional configuration and being relatively strong and light weight, said method comprising the steps of: a) providing a plurality of shaped sections which correspond to notional sections derived from a design of the object divided up into planes; wherein b) the shaped sections are made from composite material comprising a layer of suitable structural material bonded to a layer of relatively light weight substrate material, said structural material extending to an edge of the shaped section; c) joining the sections to produce the configuration, and; d) applying a coating of structural material to a surface of the object such that the object is tied together by the layers and coating thus providing strength and rigidity; wherein e) the configuration is provided by said materials themselves without need of a mould.

The term “notional sections” refers to sections conceptualized at the planning or design stage before the object is made. This will generally be accomplished by a designer using computer software well known to those skilled in the art of design.

The term “derived from a design of the object divided up into planes” refers to the object, for example a boat hull, being notionally sliced into transverse or other segments. The shaped segment which results from this process has two surfaces which correspond to the planes notionally sliced. These two surfaces are joined by an edge which substantially corresponds to the profile of the hull at that location. Although in most cases the planes are flat, curved planes are also contemplated.

The term “a layer of suitable structural material” refers to one or more layers of material which provide structural integrity to the object. The structural material utilized for the layer may be different from that used as the coating. The structural material may be any suitable material such as glass reinforced plastic (GRP) and the like, glass fibre, Kevlar fibre, carbon fiber reinforcement of resins or plastics such as polyester and epoxy resins, acrylonitrile butadiene styrene (ABS), Acetone-butanol-ethanol (ABE), sheet aluminium or other suitable material.

The term “a layer of relatively light weight substrate material” refers to the filler material which may be of any suitable which is relatively light compared to the structural material such as polyurethane, urethane rigid foam, polystyrene rigid foam or balsa wood.

Preferably the sections are sized and shaped such that each provides an accurate guide to the form of the design. The incremental addition of each of the sections during assembly of the object provides for a mould-less method.

Preferably the edges of the shaped sections in the finished object define the profile or outline of the object.

Preferably the shaped sections are of varying transverse cross-section.

Preferably the shaped sections are produced by a process of cutting, milling, grinding, carving or otherwise shaping the material.

Preferably the shaped sections are made of sheet material cut with a machine or any other appropriate means. For example Computer Numerical Control routing machinery guided by CNC software using a suitable cutting tool may be employed.

The sheets may be of any convenient thickness. The thickness may vary widely dependant on materials, engineering and economics. The webs may be relatively sparse or extremely close together hence sheet could be very thin or very thick. For a surfboard 1″ to 2″ would be appropriate. This thickness is commercially available and is convenient for CNC router tooling. It also fits well with the engineering aspect of the surfboard's shape and reinforcement advantage of webs spaced 1 or 2 inches apart.

Optionally the sections are of such a shape that when joined the laminated faces or layer of structural material are parallel or substantially parallel thus providing evenly spaced webs or ties throughout the material. Alternatively the sections may be cut from sheet material that has variable tapered thickness in one axis providing sections which are wedged shaped resulting in the laminated faces or layers of structural material being non-parallel. This being advantageous when constructing a spherical, conical or cylindrical exterior profile where webs are to be positioned radially, hence providing an increase in longitudinal strength. It may also be beneficial to have variably spaced webs and so allow more strength in highly stressed areas of the object. This may be achieved by sections cut from sheets of different thicknesses.

Preferably the planes of at least some of the laminated faces or layers of structural material are substantially perpendicular to the surface of the object.

The invention also provides a kit for making an object of a composite material, said object having a complex three-dimensional configuration according to a design and being relatively strong and light weight, said kit comprising: a) a plurality of shaped sections which correspond to notional sections derived from the design of the object divided up into planes; wherein b) the shaped sections are made from composite material comprising a layer of suitable structural material bonded to a layer of relatively light weight substrate material, said structural material extending to an edge of the shaped section, said sections being joinable to produce the configuration, said configuration having first and second surfaces incorporating said edges, whereby a coating of structural material is applicable to the surfaces of the object such that the object is tied together by the layers and coating thus providing strength and rigidity; wherein c) the configuration is providable by said materials themselves without need of a mould.

The invention also relates to a sheet of composite material for use in the method or inclusion in the kit, said sheet comprising a suitable substrate material with a suitable laminated face said sheet having cut-outs corresponding to the shaped sections.

The invention also provides a design of an object made of a composite material, said object having a complex three-dimensional configuration said design being in computer readable form, machine readable form or CNC producible form.

The invention also relates to an object made by the method of the invention.

Preferably the method of the invention will be used to produce light weight vehicle bodies, aircraft parts, vehicle components, wind turbine blades, watercraft including watercraft hulls, surfboards and the like.

In another aspect the invention provides a method of producing an object made of a composite material said object being relatively strong and light weight and having a complex three-dimensional profile, said composite material comprising a scaffold material of a foamed or fibrous character and a structural material of a fibrous and resinous character wherein said method comprises bonding a series of shaped sections of composite material to form the object, said shaped sections corresponding to at least part of the profile, which when laminated, ties the structural material together to form an array of structural members throughout the object.

### BRIEF DESCRIPTION OF THE DRAWINGS

The invention will now be described with reference to the following non limiting illustrative drawings.

FIG. 1 is a sectional perspective view of a surfboard.

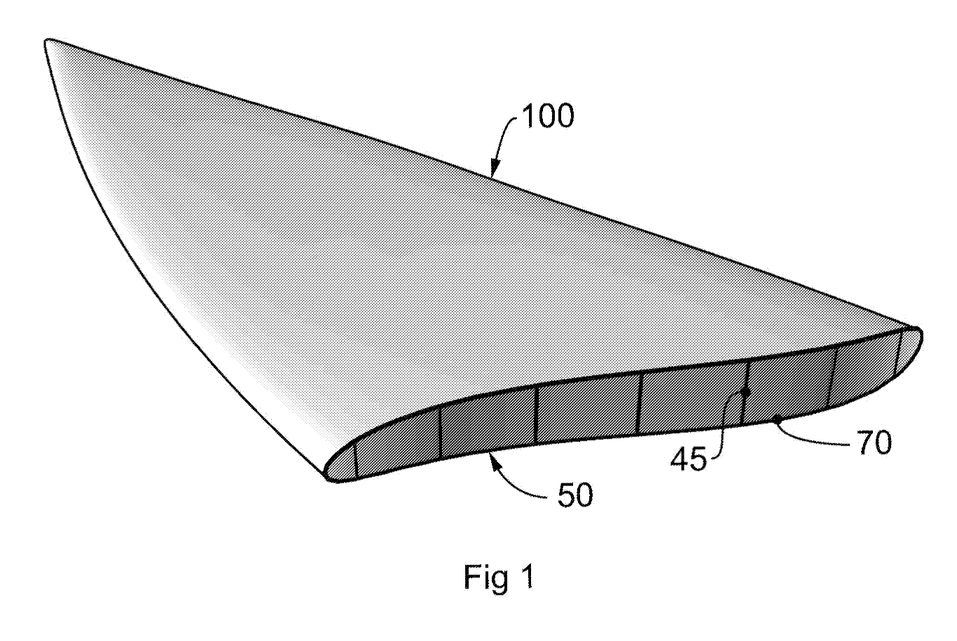

FIG. 2 is a sectional view of the composite material comprising the assembled sections with surface laminates applied to first and opposing surfaces.

FIG. 3 is schematic representation of a perspective view of an uncoated trimaran hull.

FIG. 4 is a sectional side view of a shaped section.

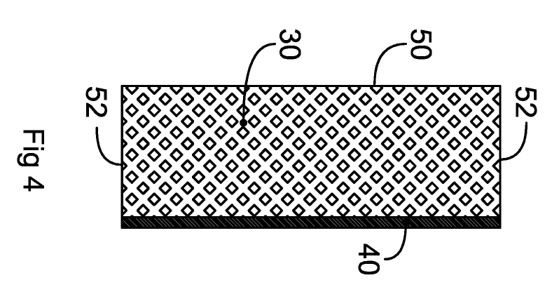

FIG. 5 is a front view of a shaped section.

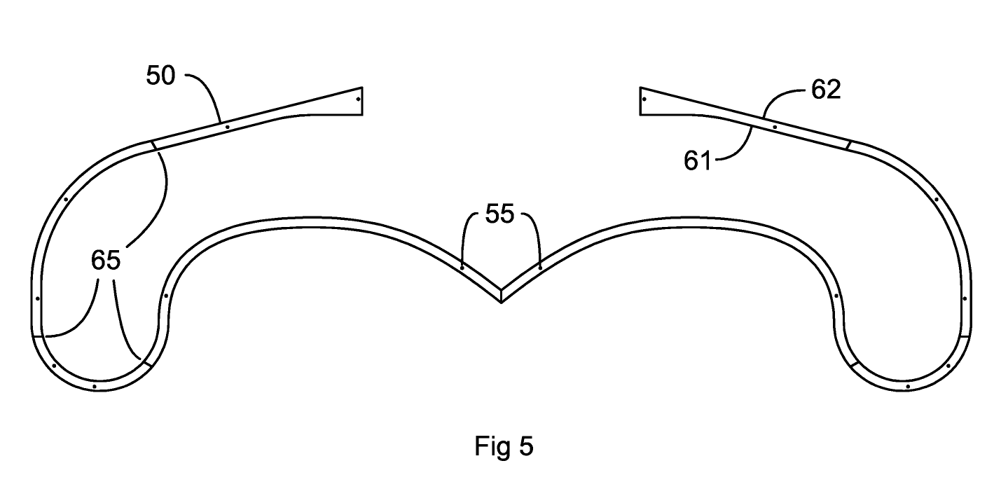

FIG. 6 is perspective views of the modules of the trimaran hull

### MODES OF CARRYING OUT THE INVENTION

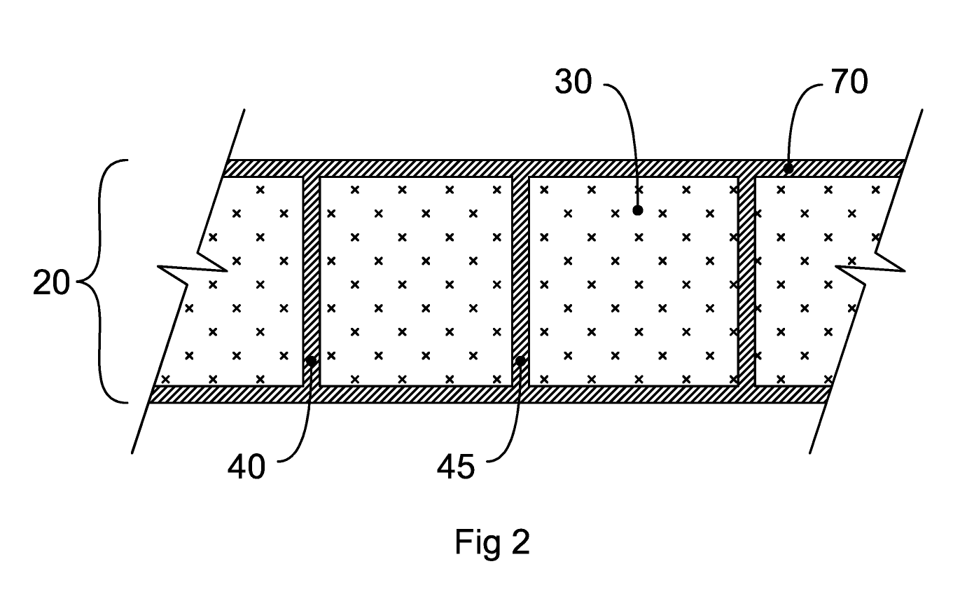

The finished object, such as surfboard 100 is composed of shaped sections 50 and has structural webs or I-beams 45 which connect with, or tie to outer laminated surface 70. Sections 50 are sized and shaped such that each provides an accurate guide to the design form required. The structural integrity provided webs 45 can be seen from FIG. 2 where the composite material 20 comprises core/substrate 30 of standard polyurethane foam bounded by laminated face 40. Laminated face 40 is a layer of structural material which together with the material used in the joining process create webs 45. Thus composite material 20 comprises layers of structural material separated by a light weight core material which in the finished object provides a sandwich composite.

Sections 50 are cut according to a design (discussed below) from a sheet of composite material 20.

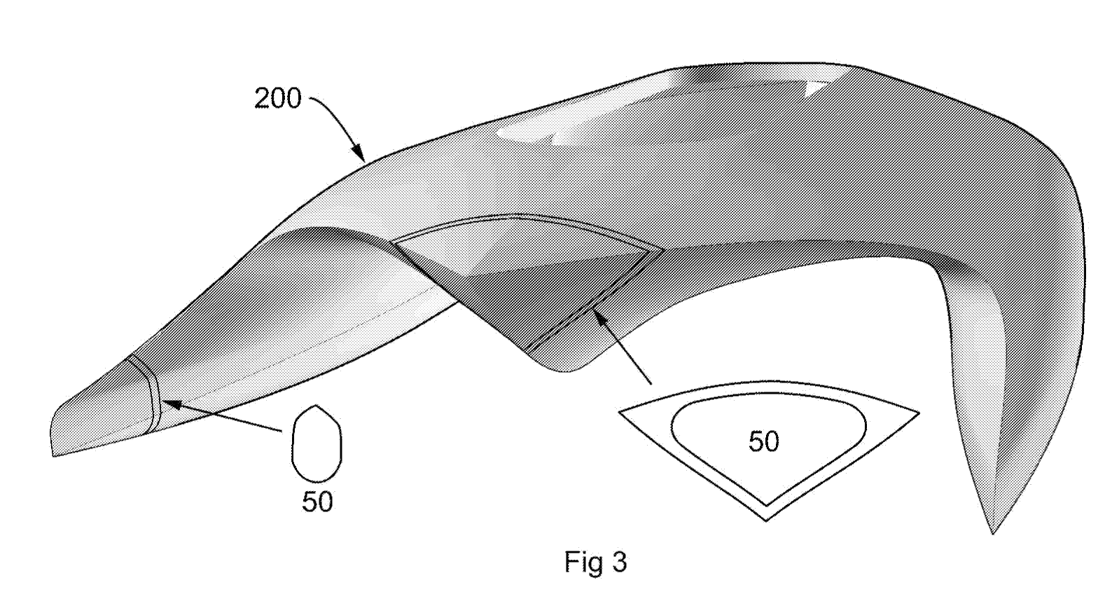

In order to make an object, sections 50 are assembled and bonded together to form an uncoated object such as hull 200 (see FIG. 3). Joining of sections 50 may be by any suitable bonding means. When assembling sections, a coat of liquid resin is painted, rolled or sprayed onto one surface and the adjacent section is brought into place. This is repeated with multiple sections and suitably clamped until resin has cured. As part of the shaping process holes 55 may drilled to accommodate locating pins to ensure accurate placement of sections 50. This is best drilled by the same machine and tool that does the initial cutting to achieve perfect accuracy. Where large sections 50 are required these may be made of smaller sub sections and joined by butt joints 65. This enables efficient use of materials. The possible reduction of structural integrity caused by these butt joints may be minimized by offsetting any joints from section to section or by using a key profile such as dovetail at the butt joint.

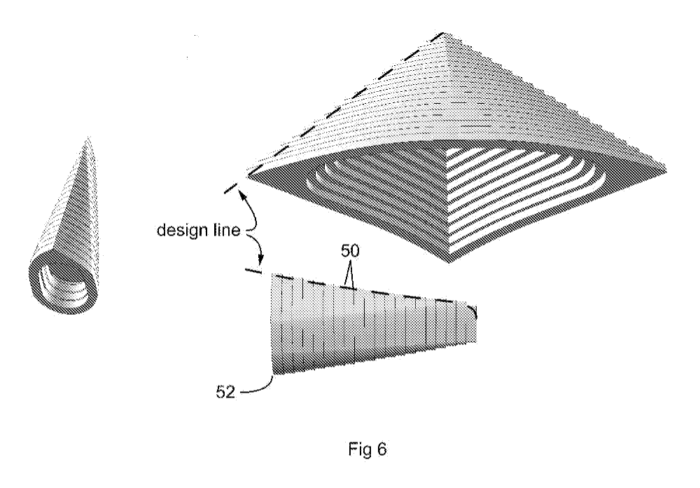

Depending on the size of the object, and other considerations, with proper support and jig arrangement, it may be possible to assemble the entire object in one continuous process. Alternatively the object may be assembled in any combination of suitably sized modules (as shown in FIG. 6) and allowed to cure, before final assembly of the module units.

Where necessary, edges 52 are faired to remove excess core and laminated face (re-enforcement material) to bring the structure to desired design specification as required (see “design line” indicated by the broken line in FIG. 6). Alternatively sections 50 are cut so that edges 52 correspond exactly to the desired profile of the object so that minimal or no fairing is required.

Once the desired complex 3-D shape such as uncoated shaped hull 200, has been assembled from sections 50 it is ready for application of surface layer of structural re-enforcement material. First and second surfaces 61 and 62 are laminated or otherwise appropriately treated by applying the chosen material to form outer laminated surface 70. This allows outer laminated surface 70 to function as a structural element which provides a hard outer skin or exoskeleton for the object. Surfaces 61 and 62 are coated so that they intersect edges 52 of layered structural re-enforcement material thereby forming an internal I-beam or web 45 providing additional strength or rigidity to the structure in at least one plane parallel to the laminated surface of the sections.

It is important that cut edge 52 and the surface finish thereof is treated to provide best possible bonding to the surface layers of structural material.

In the case where GRP is used as the structural re-enforcement material, edge 52 would be somewhat “feathered” by cutting with a high speed rotary tool. This means that the glass fibers are pulled and separated from the resin material. Thus feathering lends itself very well to bonding to the surface layers where these loose fibers become integral to the surface layers during the outer layer bonding or coating process.

It will be appreciated by those skilled in the art that core material 30 may be in sheet form of (t) thickness and the ratio of core material (t) thickness to structural reinforcement material (s) in the form of laminated face 40 is varied according to weight and strength requirements of the 3D object.

### Example 1

### Production of a Complex 3D Object

A complex 3D object may be produced by the following steps:

Step 1.

An object is designed creating a plan in 3 dimensions which plan is divided into multiple sections by strategically spaced planes so as to provide a series of sectional profiles of the 3 dimensional form. The 3 dimensional form is conveniently designed with CAD or CAM computer software. Utilizing the facilities available in the software application, an array of planes can easily be generated and the profiles exported to individual files and/or defined as individual objects. These objects or files could be 2 dimensional or 3 dimensional depending on the type of machine cutting process to be employed in step 3.

During the CAD/CAM design process allowance may be provided to ensure proper alignment of each section which is carried out in step 4. This is achieved by allocating matching drill points for each adjacent profile section. During step 3, the cutting process, these drill points are CNC drilled to a specific size providing for insertion of dowel locating pins prior to assembly of each section in step 4.

Step 2.

A flat sheet of structural material is bonded to a flat sheet of lightweight core material providing a sheet of composite construction material. The total thickness of the sheet this composite construction material is determined by the spacing of the planes in step 1. Alternatively if sections are required to form non parallel webs, wedged shaped sections could be cut from a solid block of core material. In the case of polyurethane foam a “hot wire” slicing machine could be utilized. Use could be made of alternate slices, which having opposing angles could conveniently allow a new layer of structural material to be bonded to the surface of the block prior to each slice.

As will be appreciated by those skilled in the art, composite construction is the concept of using multiple materials in a way to gain advantage from the properties of each of the materials in use. In this case the “structural” material has high mechanical strength but is relatively heavy. The core material is light weight but with enough rigidity to support the structural material in its framing structure. The thickness of structural layer and thickness of core layer is determined by the required strength to weight ratio and overall engineering of the design.

Step 3.

The sectional profiles of the designed 3 dimensional object are cut from the composite construction material.

Each of the sectional profiles are prearranged and orientated by the CAD/CAM software or “Nesting” software to make efficient use of the sheet of composite material and reduce waste. This cutting process is most easily carried out by CNC machinery, for example, a three axis or five axis router table, with vacuum facility to clamp the sheet of composite material.

The composite sheet is mounted to the table with structural layer upper most so that the cutting tool penetrates structural layer completely. The core layer need not be cut all the way through: a small part of the core material left uncut at the bottom face so as to hold the sectional profile firmly in place as the cut proceeds may be advantageous. Alternatively the machine may leave tabs to ensure the sheet remains intact. In that way the complete sheet can then be lifted from the table and transported with all the sectional profiles held in place until they are needed. The intact sheet with shaped section cut outs could also be provided as part of a kit for making the object.

A simple 3 axis router table will cut sectional profiles with edges perpendicular to profile face surface. However it may be advantageous to use CNC machinery that has the ability to cut profile edges at various angles as determined by the profile of the 3D form and interpreted by the CAD/CAM software in which case a 5 axis machine would be necessary.

Step 4.

The sectional profiles are incrementally bonded together in proper order, orientation and position in relation to each other to provide the 3 dimensional form. The CAD/CAM design process in step 1 allows for proper alignment of each section. Dowel locating pins inserted in the drill points prior to assembly of each section therefore providing perfect alignment.

Step 5.

External and internal surfaces of the 3 dimensional form are mechanically faired to achieve the desired specification.

This may be necessary if sectional profiles have cut edge surfaces perpendicular to face surfaces. In that case where the designed internal and external surfaces of the 3 dimensional form are not perpendicular to the face of the sectional profiles, a stepped surface results which requires mechanical or manual fairing. This would need to be taken into account during the CAD/CAM design process. If CNC machining is used to provide non perpendicular edges of sectional profiles, some fairing may still be necessary to achieve a surface suitable for step 6.

Step 6.

Structural material is applied to external and internal surfaces of the 3 dimensional form by suitable bonding process ensuring that these surface layer(s) bond securely with exposed edges of sectional structural material.

The intersection of surface structural material and sectional structural material provide an array of “I” beam elements, and with proper bonding realize exceptional strength and rigidity in the plane of each of the sectional profiles. In the case of structural material of GRP, glass fibers are torn from reinforcing resin during cutting process. The loose ends of these fibers mesh with fibers of surface layer(s) creating a stronger bond.

### Example 2

### Production of Trimaran Hull

Boat hull external and internal surfaces for a 14 foot trimaran were designed by CAD utilizing Rhinoceros (Rhino). This is a stand-alone, NURBS-based 3-D modeling software, developed by Robert McNeel & Associates. These external and internal surfaces were notionally sliced into 26 mm thick “sections” and parts for CNC machining were developed from these sections along with drill points for locating pegs for each part ensuring properly positioned assembly of parts. Each part was exported to its own separate DXF file. There were 922 parts for this 14′ hull.

Polyurethane core material by the trade name Divinycell® (DIAB) was used for the core or substrate material of the trimaran hull. Divinycell® is relatively expensive but rated for marine applications. The most common size sheeting is 8×4′ and 1″ thickness and 60 kg/m³ density was used for this project.

Fiber glass was used as the structural material for forming the laminated faces and surfaces. Fiber glass cloth is available in many types and configurations the most common biaxial with a weave of fibers in two 90 deg opposed directions. The other most common type random directional “cloth” commonly referred to as “mat”. All are available in a range of weights or densities and usually rated in ounces, eg. 4 oz cloth is the weight of 1 sq. yard of dry cloth. Initially 6 oz bi directional cloth was used for lamination to the foam sheet to form the ‘ribs’ or ‘webs’ integral with the core material. Later 8 oz cloth was used as described below.

The laminated faces and surfaces comprising structural material are normally made of some type of resin reinforced with some type of fiber, most commonly glass fibers. There are two main types of resin: polyester and epoxy. There many grades of both types, but epoxy is gaining in popularity mainly because of safety concerns and tightened regulations concerning use of polyester due to the toxins involved.

The construction of the hull was by “hand layup” technique where all fiber glass cloth was applied by hand without moulding. Epoxy resin was used mainly because of increased strength which maximizes the high “strength to weight ratio”.

The type of epoxy used is classified as a laminating epoxy (with lowest viscosity) mixed with ‘slow’ hardener at a ratio of 5:1. Working time (resin remains sufficiently liquid to soak into glass fabric) is rated at 25 minutes. Pot life is not rated and entirely dependent on the volume of resin that has been mixed. Mixed resin produces heat and that heat speeds the curing reaction, resulting in a thermal runaway. Therefore pot life can be as little as 5 minutes for any quantity over 100 ml.

One 8×4′ sheet of 1.0″ 60 kg/m³ foam was laminated with one layer of 6 oz fiber glass cloth impregnated with the epoxy resin. It was later found that 3 layers of lamination provide a greater structural advantage.

A group of part files were imported to an online “nesting” service which arranges and orientates parts for most efficient use of material. This service exports a set of 16 DXF files each representing one 8×4′ sheet with an average of 58 parts superimposed, with drilling points on separate layer, and part number labels on another layer of the drawing. Material usage was only 44.5% given the irregular shape of most of the parts and the fact each is of a different shape and dimension. Better material usage percentage usage may have been achieved with other nesting software. CNC routing applications and CAD/CAM software often have nesting facilities.

A DXF file of 67 parts was submitted to a local sign manufacturing business who imported to their routing software application and tool paths calculated. Sheet was cut by 8×4′ CNC 3 axis routing table with vacuum clamping facility. The 67 parts comprised the first 22″ of the boat's bow. Dimensional accuracy of the parts exceeded expectations, measurements closer than 0.1 mm to specification. Sheet was not cut all the way through by request and a thin layer at the bottom of the sheet left in place to hold the parts in place within the sheet while each cut is completed and for transportation of the sheet. The whole operation was completed within an hour.

Parts were separated from the sheet and assembled dry with locating pegs and checked for fit. All fitted perfectly. The 3/16″ wooden locating pegs were glued in place with 5 minute epoxy (2 pegs for each part).

The hull was built in 8 modules separated transversely. Then parts for each the modules (see some of the modules in FIG. 6) were glued together with same laminating epoxy starting with the largest part laying on a flat surface. The gluing process for each module took less than 10 minutes. A clamping arrangement presses all parts together while epoxy cures and so producing the rough “plug”.

To trial the fairing process, a 5″ orbital sander was used to take the excess foam from one surface of the central hull. This took several minutes. When the whole hull was assembled a belt sander was used to speed up the process. The internal surface required filling with a light weight mixture of resin and glass microspheres.

During the fairing process it became clear that fairing is much quicker and easier than filling. The light weight filler is still heavier than the core material and adds unnecessary weight. The stepped surface on the exterior produced right angled steps of foam core and were easily sanded away to meet the edges of the web which served as the sanding guide. On the internal surfaces that stepped surface consists of the exposed web backed by foam core. As with the external surface, the exposed web and foam are easily sanded away using the internal corner of the step as a guide. This has the effect of some loss of design thickness of the hull wall so for future designs this will be taken into account where object surfaces are not perpendicular to the sections. When sanding the internal concave surfaces a rotary sanding drum of appropriate diameter was used or sanding flapper wheel. The inventor used an electric drill and electric barrel mill. On large radius curves an orbital sander or belt sander can be used.

The internal surfaces of each module were laminated before modules were assembled together to allow for easy access. As modules were adhered together, again with epoxy resin, the joints are finished internally with further layers of fiber glass.

The inventor notes that a template top and bottom of each module could be used during the gluing of parts. Bottom section would be laid on a flat surface and be aligned by a template probably consisting of a sheet of thin ply or similar. This template would be cut using the same machinery and method as parts were cut. This is to ensure the correct profile in cases where multiple parts make up a section. The top template would be fitted when all parts of the module are assembled and before glue has begun to cure. It would also form part of the clamping arrangement. In this way modules are held in perfect alignment so that modules can be fitted together easily.

The faring/filling process could be minimized or eliminated by utilization of a 5 axis router table and cutting the appropriately angled edge of all the parts. In that case no surface fairing would be required. This would allow a builder to take advantage of the rough cut edge of the fiber glass laminate. It was noticed under the microscope that the loose ends of the glass fibers had been cut off clean after sanding. This will reduce the strength of the bond between webs and surface layers. With a 5 axis router, the surfaces would be smooth enough for an application of surface fiber glass directly to machine cut surface, which has “furry” edge. Fairing compound would be added over top of fiber glass layer to finish.

While the inventor was unable to locate a suitable 5 axis router table and used the “stepped” method of construction using 2 axis machines he noted that conversion of the 2D DXF files to a 3D file should not be difficult if a 5 axis machine is to be utilized.

In the hull produced, sanding was employed as a way of preparing for subsequent resin application over cured resin surfaces. Other methods of surface preparation commonly in use are solvent application or washing with water.

The inventor found the completed hull to have impressive rigidity and light weight and considers further reduction in weight could be achieved while maintaining a high degree of structural integrity.

### Example 3

### Testing of Material

Test beam samples were manufactured consistent with the method of the invention. The test beams consisted of 100 mm wide beams with webs and surfaces of 3ply 8 oz epoxy fibreglass and 60 kg/m³ polyurethane foam. Beam thickness was 28 mm and webs where spaced almost symmetrically at 26 mm longitudinally, 4 webs per beam. Other test beam samples were manufactured without webs in a standard sandwich composite configuration. These beams were also 100 mm wide and also used 3ply 8 oz epoxy fibreglass on upper and lower surfaces. 3 different thickness beams were manufactured, with 60 kg/m³ density foam core of 1.0″, 1.5″ and 2.0″ resulting in beam thicknesses of 27.5 mm, 40.5 mm and 53 mm respectively. Testing was carried out using a single point load by way of steel bar radius 30 mm contacting beam surface perpendicular to beam length. The 3 standard beams and the webbed beam were each tested while centred on supports 300 mm apart and the point load applied to beam centrally between the fixed supports. This is a standard mode of testing of steel or wooden beams and the calibrated hydraulic ram applied load while inches deflection and pounds load was recorded at intervals until the beam failed. During testing of standard beams it was noted that considerable damage to surface of beam occurred at point load contact area well before beam collapsed altogether. Further testing was carried out with a 4 point loading system where wooden blocks were arranged to distribute load around 4 points across beam, spaced 50 mm around centre of beam between supports. The results are given in table 1 below.

TABLE 1
Results of Flexural Testing on 3 ply Beams

| | Sample Name: (inches) | | | |
|---|---|---|---|---|
| | C: 1⅝ × 4 | F: 2⅛ × 4 | I: 1⅛ × 4 | L: 1⅛ × 4 |
| | Standard | Standard | Standard | Invention |
| 1 point | 450 | 1000 | 330 | 1160 |
| Max load (lbs) | | | | |
| Max deflection | 0.448 | 2.00 | 0.210 | 0.340 |
| (inches) | | | | |
| Stress | 762 | 1014 | 1266 | 4467 |
| (lbs/sq.in.) | | | | |
| 4 point | | 1550 | | 2040 |
| max load (lbs) | | | | |

### OTHER APPLICATIONS

It is envisaged that the method of the invention may be used to make large objects such as a 75 meter long turbine blade for wind power generation. This requires the structural material to be available in a continuous length ie. on a roll. The structural material is glued to the sheet of substrate material as it is pulled off the roll, clamped for cure, and then moved longitudinally over the CNC table. One part of the section is cut sequentially at a time as it passes over the table and as long as the structural lamination is continuous the finished section can be very long in one axis. In the perpendicular direction (width) section size is limited by width of roll and CNC table. Constraints of substrate sheet size, and CNC table size are partially overcome in this way.

Aluminum and “Prepreg” GRP are both available by roll as structural lamination material for the above. It may also be feasible to use a light weight substrate material from a roll also.
Materials from the roll would need to be accurately guided by a roller system, possibly with edges being machined after release from the gluing process as it is moved to the CNC table. It is also conceivable that materials flow continuously through such a process, the CNC cutting head synchronized with material motive machinery.

It can be seen from the above description that the present invention provides a convenient and cost effective way to fabricate a light weight, strong object having a complex 3D configuration without the use of molding. This allows economic design modification which may be extremely advantageous where it is desired to change the design of a product frequently or make inexpensive prototypes at the initial stages of product design.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

Throughout this specification and the claims that follow, unless the context requires otherwise the words “comprise”, “comprises”, “comprising” will be understood to mean the inclusion of the stated integer, step or group of integers or steps but not the exclusion of any of other integer, step or group of integers or steps.

1. A method of producing an object made of a composite material said object being relatively strong and light weight and having a complex three-dimensional configuration, said method comprising the steps of:
providing a plurality of appropriately shaped sections bonded together into the three-dimensional configuration, each section comprising a core material with a suitable laminated face extending to an edge thereof and said configuration having first and second surfaces incorporating said edges, wherein the sections by themselves provide rigidity to the nascent configuration when sequentially assembled;
laminating or otherwise sealing said surfaces and edges;
wherein said laminated faces form a series of structural webs connecting said first and second surfaces; and
wherein the configuration is provided by the materials themselves without need of a mould.

2. (canceled)

3. The method of claim 1 wherein the edges of the shaped sections define a profile of the object.

4. The method of claim 1 wherein at least some of the shaped sections are of varying transverse cross-section.

5. The method of claim 1 wherein the shaped sections are made of sheet material.

6. The method of claim 1 wherein the sections are produced by cutting.

7. The method of claim 1 wherein the sections are produced by cutting with Computer Numerical Control (CNC) routing machinery.

8. The method of claim 1 wherein the webs are disposed perpendicular to, or substantially perpendicular to, the first and second surfaces.

9. The method of claim 1 wherein the sections are sized and shaped such that each provides an edge or part thereof which is an accurate guide to the form of the design.

10. An object made from the method of claim 1.

11. A kit for making an object of a composite material, said object having a complex three-dimensional configuration according to a design and being relatively strong and light weight, said kit comprising:
a plurality of shaped sections which correspond to notional sections derived from the design of the object divided up into planes;
wherein the shaped sections are made from composite material comprising a layer of structural material bonded to a layer of relatively light weight substrate material, said structural material extending to an edge of the shaped section, said sections being joinable to produce the configuration having first and second surfaces incorporating said edges, whereby a coating of structural material is applicable to the surfaces of the object such that the object is tied together by the layers and coating thus providing strength and rigidity;
wherein the configuration is providable by said materials themselves without need of a mould.

12. The kit of claim 11 wherein the object is a watercraft or a surfboard.

13. A sheet of composite material for inclusion in the kit of claim 11 comprising a core or substrate material with a suitable laminated face or structural material bonded to said core or substrate material, said sheet having cut-outs corresponding to the shaped sections.

14. An object made from the method of claim 1 wherein the webs or layers of structural material are parallel or substantially parallel to one another.

15. An object made from the method of claim 1 wherein the object is a watercraft, a surfboard, a pressure or vacuum vessel, a transportable liquid tank, a vehicular bridge section or ramp for a truck or utility mount, a man handle ramp or bridge, a roll on roll off (RORO) ramp for ships, a vacuum pipe, an aircraft wing or other aircraft part, an aircraft body, an aircraft fuel tank, a space capsule, a car body, a ski-mobile body, a train carriage, a survival capsule or a wind turbine blade.

16. A computer readable form, machine readable form or CNC (Computer Numeric Controlled) producible form of an object having a complex three-dimensional configuration represented by its notional sections when used in the method of claim 2.

17. (canceled)

18. A method of producing an object made of a composite material said object being relatively strong and light weight and having a complex three-dimensional profile, said composite material comprising a scaffold material of a foamed or fibrous character and a structural material of a fibrous and resinous character wherein said method comprises:
bonding a series of shaped sections of composite material to form the object, said shaped sections corresponding to at least part of the profile, which profile when laminated, ties the structural material together to form an array of structural members throughout the object.

19. (canceled)

20. A method of producing an object made of a composite material, said object having a complex three-dimensional configuration and being relatively strong and light weight, said method comprising the steps of:
providing a plurality of shaped sections which correspond to notional sections derived from a design of the object divided up into planes,
wherein the shaped sections are made from composite material comprising a layer of structural material bonded to a layer of relatively light weight substrate material, said structural material extending to an edge of the shaped section;
joining the sections to produce the configuration; and
applying a coating of structural material to a surface of the object such that the object is tied together by the layers and coating, thus providing strength and rigidity,
wherein the configuration is provided by said materials themselves without need of a mould.

21. The method of claim 20 wherein the edges of the shaped section define a profile.

22. The method of claim 20 wherein at least some of the sections are of varying traverse cross-section.

23. The method of claim 20 wherein the shaped sections are made of sheet material.
